(19) United States
(12) Patent Application Publication
(10) Pub. No.: US 2009/0167559 A1
(43) Pub. Date: Jul. 2, 2009

(54) Advertising system and method of use

(76) Inventors: Kent B. Gaddy, Gravette, AR (US); Robert Dale Taylor, II, Farmington, AR (US); Robert L. Woodard, JR., Bentonville, AR (US)

Correspondence Address: Galasso & Associates, LP, P.O. Box 26503, Austin, TX, 78755-0503, US

(21) Appl. No.: 12/006,135

(22) Filed: Dec. 31, 2007

(51) Int. Cl. G08G 1/00

(52) U.S. Cl. 340/901

(57) ABSTRACT

A vehicle messaging system operably connected to a communications network that is configured to receive, store, manipulate, view and transmit data. The vehicle messaging system is mounted within the interior of a vehicle and further includes the necessary electronics to determine its geographic coordinates and transmit that data across the communications network. The communications network functions as a conduit to allow organizations or individuals to send and receive information such as but not limited to advertising messages to vehicle messaging systems connected to the communications network. The vehicle messaging system is operably connected to the communications network utilizing wireless technology such as but not limited to short-wave, RF or cellular frequencies.

### FIELD OF THE INVENTION

The present invention relates to a message system, more specifically but not by way of limitation, to a system including an advertising receiver/transmitter device designed to be mounted within a vehicle, or carried as a personal device and is capable of receiving and re-transmitting received messages and information.

### BACKGROUND

Internet advertising is a multi-billion dollar per year industry. For an organization attempting to market a product, the value of advertising is derived from the ability to direct an advertisement message direct to a specific consumer that is known to have a potential need for a product or service. Control over the advertisement message in terms of when, where and how the advertising message is delivered is critically important to the advertiser.

Several problems exist when utilizing conventional advertising methods. Typically, advertisers place ads utilizing a variety of channels in speculation that the individual receiving the message at that point in time or at some point in time in the near future has a need for the product or service advertised. Unfortunately, it has been shown that this is not usually the circumstance.

Another issue with current broadcast adverting methods is they do not allow the advertiser to know the physical location of the targeted consumer at any point in time. The ability to derive this information combined with a targeted message to a specific consumer would drive tremendous value both for the advertiser and the targeted consumer.

Accordingly, there is a need for an advertising system and method that would allow an advertiser to know the geographic location of a targeted consumer and utilize a method that would facilitate the timely delivery of an advertisement message to the targeted consumer.

Due to all of the advertising being controlled by a central web-site, the web-site can control the amount of advertising messages delivered by controlling the price. If more geographic locations are more prone to accidents, then the price may be higher or the ability for the receiver/transmitter not display the message and allowing it to be uploaded to the profile of the users receiver/transmitter.

### SUMMARY OF THE INVENTION

It is the object of the present invention to provide a messaging/advertising system to an entity that desires to broadcast a message to a targeted receiver/transmitter which can be mounted in a vehicle, or carried as a personal device.

A further object of the present invention is to provide an advertising system that utilizes a website interface for facilitating the input of at least one advertising message to be broadcast to a targeted consumer. Additionally the website is can be used as an end user interface to review messages received by the user's own receiver/transmitter, thus giving the option that the transmitter/receiver does not always have to screen all messages received.

An additional object of the present invention is to provide an advertising system that has the capability of determining the geographic location of a targeted consumer.

Yet another object of the present invention is to provide an advertising system that utilizes a device that functions as a transmitter and receiver at the same time.

A further object of the present invention is to provide an advertising system that utilizes a device that can receive advertisement messages, or forward advertisement/messages as a result of being in the vicinity of another receiver/transmitter with the ability to filter advertisements/messages.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagram of one embodiment of a message communications network for the advertising system; and

FIG. 2 illustrates a preferred embodiment of a message receiver/transmitter in accordance with the principles of the present invention.

### DETAILED DESCRIPTION

Referring now to the drawing submitted herewith, wherein various elements depicted therein are not necessarily drawn to scale, there is illustrated a message/advertising system 100 constructed according to the principles of the present invention.

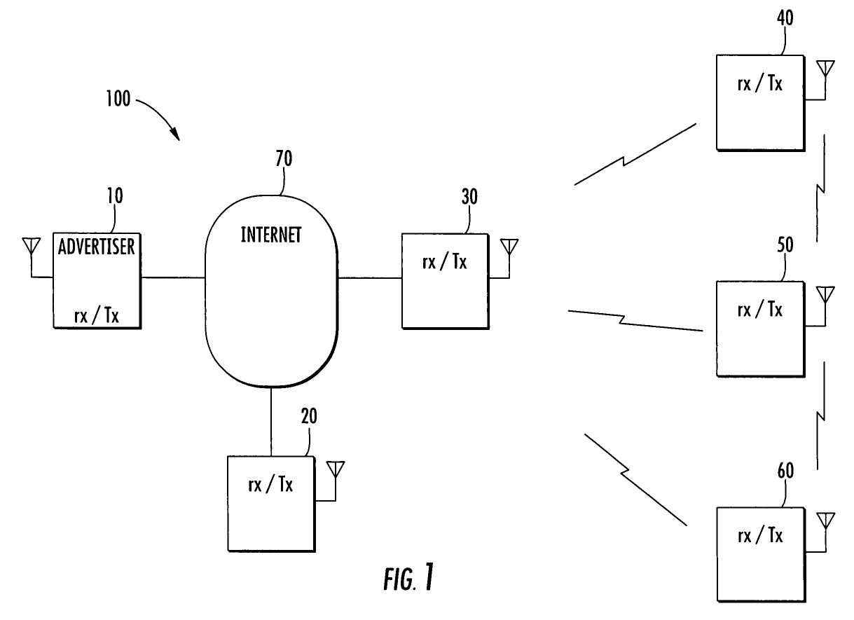

Referring in particular to FIG. 1 there is depicted a message/advertising system 100. As illustrated, message/advertising system 100 includes multiple receiver/transmitters such as receiver/transmitters 10, 20, 30, 40, 50 and 60, each of which are operable to intercommunicate with each other, primarily through a wireless connection or through a wired connections, such as through a network or the internet.

In general operation, user of receiver/transmitter 10 would log onto an “advertising” web site via the internet and either upload a pre-created ad, or create one via advertisement website. The ad would then be transmitted to other users either via any receiver/transmitter in range of users with receiver/transmitters, such as buy the user of receiver/transmitter 20, or would be wireless transmitted to various users via receiver/transmitter 30.

Based upon each of the users setting, each of the receiver/transmitters 20, 40, 50 and 60 would decide to display a received ad, but would always continue to retransmit or repeat the ad to other users within range.

It is contemplated within the scope of the present invention that a receiver/transmitter could be designed to be mounted in a car or other vehicle, or even designed as a personal device. Furthermore, it is contemplated within the scope of the present invention that a receiver/transmitter be integrated into a personal electronic device such as but not limited to a cellular phone.

In one embodiment of the present invention, a user of receiver/transmitter 10 will login to web page utilizing internet 70 and more specifically to a profile that has either been set up for the user or setup by the user themselves. If it is the user's initial access to the web page the user will be prompted to input required information such as but not limited to create profile account information.

Subsequent to creating a profile, the user will enter a specific advertising message that the user would like to broadcast to at least one or more receiver/transmitters on the messaging/advertising system 100. The advertising message will be created via an advertising website by the user that can include textual or graphic information. Following the creation of the specific advertising message, the user will identify and choose the date and time for the advertising message to be delivered based on the price. Additionally, the user will have the option of choosing data concerning the reoccurrence and frequency of the advertising message to be delivered to the receiver/transmitters. The user will further choose whether or not the advertising message should be retransmitted in between each of the receiver/transmitters.

Additionally, the user can input a predetermined frequency and count of the advertising message to be delivered. For example, the user can choose that the advertising message should be repeated 20 times between receiver/transmitters wirelessly of each receiver/transmitter in range. For example, if the range is ¼ mile, then 20*¼ would be 5 miles. The receiver/transmitter would then cease broadcasting the advertising message. Each of the receiver/transmitters contains therein the necessary control electronics to perform this function.

Based upon dates and time, the user will have the option to input how long the advertising message will continue to any receiver/transmitter within range of the repeated hops across each receiver/transmitter. For example, entering a time-to-live of thirty seconds would dictate that the advertising message would continue to be repeatedly delivered through the messaging/advertising system 100 for a time period of thirty seconds.

A user may also have the option to include an audio data file with the graphical or textual advertising message. Once complete with a particular advertisement, the web page tracks the type and amount of data entered by the user and utilizes an algorithm to calculate a fee for the user. Each time an additional option is presented via the advertising website, a price is presented to the end user. The web page contains or is operably connected to a merchant account provider that facilitates collecting payment utilizing a credit card or bank account information. Once the payment transaction is complete at the website, it will be downloaded to the receiver/transmitter on the business' building, then the receiver/transmitter will transmit the advertising message according to the instructions inputted by the user. The downloaded message is encrypted using typical methods, such as but not limited to AES, that is compatible with only the owner's serial numbered receiver/transmitter.

In one embodiment of the present invention each receiver/transmitter utilized in receiving an advertising message can further function as a receiver to receive messages from each receiver/transmitter operably within range of any receiver/transmitter to the messaging/advertising system 100. For example, in this embodiment each of the receiver/transmitters 10, 20, 30, 40, 50 and 60 could communicate with each other if they are located proximate each other within a pre-determined radius. It is also contemplated within the scope of the present invention that the receiver/transmitters further include the necessary electronics to be able to receive signals from global positioning satellites and have the ability to calculate its geographic location. It is contemplated that this data could be utilized to allow a user to perform trip-mapping tasks with the receiver/transmitter. Furthermore, the receiver/transmitter could be utilized to identify the location of a car in which it is disposed in the event the car was stolen. Ultimately the GPS data would be received by a business receiver/transmitter connected to the internet and the business receiver/transmitter would upload to the advertising website the current location.

In one embodiment of the present invention, a user will be able to utilize system 100 to communicate to a web page, specific user information to create a profile of the user. For example, the user will be able to input age, marital status, dependent information, hobbies, eating habits, category type such as truck driver, delivery person, and any preferences like metropolitan street, highway and the like. This will allow a receiver/transmitter to be customized to the user's preferences and information to allow an advertiser utilizing system 100 to target a specific consumer having a receiver/transmitter on the system 100. An example of some of the user preferences can include but are not limited to: emergency receive only, user warnings, parking information, advertising, peer to peer chat functions and allowance, audio alerts to be associated with the different functionalities activated by the user either on receiver/transmitter or via the advertising website to make it easier.

In one embodiment of the present invention, the receiver/transmitter can further be programmed via a web page or utilizing the device itself, to identify categories of vehicle or driver types. For instance, it is contemplated within the scope of the present invention that the receiver/transmitter can be programmed by a user to identify categories such as but not limited to: truck driver, delivery person, metropolitan areas, or highway only functions. It is further contemplated within the scope of the present invention that the receiver/transmitter can be utilized as a trip planner utilizing information provided to the receiver/transmitter from the message/advertising system 100 to determine routes and route preferences. This route information is then distributed to advertisers who can choose whether or not to broadcast an advertising message to the receiver/transmitter when they are proximate their business, or to give the user options on advertising website for discounts prior to starting a trip, which can give user options. For example, a user may decide to take a detour by a theme park and will receive a discount corresponding thereto.

In another embodiment of the present invention, the receiver/transmitter can be enabled by the user to receive advertising messages from an individual as opposed to an organization. Furthermore, the receiver/transmitter contains the capability of discerning the identity of the user and tag different levels of messages with different priorities and whether or not to display on the receiver/transmitter or wait until the receiver/transmitter can download the message to the owner's profile on the advertising website for viewing at a later time. For example, if a user receives an advertising message from an individual, a user has the ability to program the receiver/transmitter to tag that message with a lower priority as opposed to a message from an organization. It is further contemplated within the scope of the present invention that the receiver/transmitter can be programmed to scan the incoming data for a particular keyword. For example, a user can program the receiver/transmitter to search all incoming messages for the word Camaro. These messages are then identified as a high priority and displayed to the user first and to be displayed or to even display at all. It is also contemplated that this could be achieved using categories such as restaurants, department stores or airports. The receiver/transmitter can further be programmed to limit the total number of incoming messages to be displayed or delayed to the advertising website when it is uploaded and also set permissions for messages that can be receive from broadcasters. As each incoming message is presented, a priority can be set by the user. For example, a male user may not want to display advertising related to cosmetics or places that sell cosmetics, while a female user may want to give low priority to car dealerships, hardware stores and the like.

In one embodiment of the present invention, the receiver/transmitter is configured to operably connect to the message/advertising system 100 utilizing 802.1x wireless technology. For example, a user could access the web page and make changes to their profile. Subsequent to changes being made in the profile, the changes are downloaded to the vehicle messaging system, 40, 50, 60 utilizing the aforementioned wireless technology. From word a user could connect to the internet 70, and change their profile. When the user returns home, they could connect to a WiFi connection where the receiver/transmitter would connect to their profile on the website and download the changes in the profile and upload messages that have been received by the receiver/transmitter.

In another embodiment of the present invention, the receiver/transmitter can be utilized in a manner similar to that of an electronic billboard for organizations to broadcast a message to a user of a receiver/transmitter that is proximate their business' receiver/transmitter. For example, many businesses are not located proximate a highway or street that allows conventional signs or billboards. Utilizing the message/advertising system 100 a registered user can program a message to be delivered to all receiver/transmitters that are proximate the user's business within a certain radius. More specifically but not by way of limitation, a gas station could send a message to all receiver/transmitters proximate the gas station the current price on gas or some other item. This message could be delivered via the message/advertising system 100 once or a plurality of times during the day. To limit the range, the receiver/transmitter could be set for the number of times to be repeated. A “zero” would tell each receiver/transmitter that receives the message not to retransmit it. Additionally, a business within a certain distance from its digital sign on the highway, such as 1 mile, would be able to update its own display via the receiver/transmitter attached to the sign.

In another embodiment of the present invention, the receiver/transmitter can be programmed by a user or users utilizing a web page to alert at least one proximate receiver/transmitter with information on a yard sale. More specifically but not by way of limitation, a user can utilize the web page to repeatedly notify users of the receiver/transmitter when proximate the yard sale as to when and where it will be occurring. Furthermore, reminders of this event are also programmed into the receiver/transmitter so a user can search the receiver/transmitter for such events. It is further contemplated within the scope of the present invention that the awareness of events such as but not limited to yard sales can be used to facilitate collaborations between users of the receiver/transmitter to create events greater in scope or via advertising website a user could be presented with three within 1 mile and for a fee, the user can get contact information so that they could partner with others for a larger yard sale.

In one embodiment of the present invention, the receiver/transmitter can be programmed with an itemized shopping list and the location of the store preference where to purchase these items. More specifically but not by way of limitation, the user can program the receiver/transmitter with a list of items that are arranged in a relational database with the corresponding store from which these items are purchased. When a user utilizing the receiver/transmitter is within proximity of the store where an item on this list can be purchased, the receiver/transmitter knowing its geographical location as well as having in its memory electronics (not expressly shown), a message will be generated by the receiver/transmitter to the user regarding the item that may need to be purchased. It is further contemplated that the receiver/transmitter can be programmed to maintain the frequency of purchase for any item and create an associated list whereby the user of the receiver/transmitter would be alerted as to items that are normally purchased along with the item of notification (such as bread and milk@a select convenience or grocery store). Furthermore, categories such as anniversaries, birthdays or vacations could also be programmed. It is also contemplated that the receiver/transmitter could receive instant coupons and/or resale opportunities of previously purchased items such as but not limited to vacations.

In one embodiment of the present invention, the receiver/transmitter can be utilized by a financial institution to transmit information such as but not limited to stock quotes. Furthermore, the receiver/transmitter can interface with local traffic bureaus or news agencies via the message/advertising system 100 to alert users as to proximate traffic flow issues. These agencies could be affixed with a receiver/transmitter such that a picture or audio could be presented corresponding to information such as a wreck or traffic congestion.

In another embodiment, the receiver/transmitter can be programmed to receive and identify with a priority resumes of individuals seeking employment and/or employment opportunities. More specifically but not by way of limitation, a user can program specific employment opportunities in certain fields and/or scan for resumes posted to the receiver/transmitter with keywords for a particular experience level. A user looking for a job, may want to know about jobs of local businesses looking for help or hire just by driving thereby limiting or eliminating the needless time spent looking by conventional methods.

In a further embodiment, the vehicle messaging system 30, the receiver/transmitter will receive via the message/advertising system 100 from newspaper organizations. More specifically but not by way of limitation, the receiver/transmitter can be programmed to receive sports scores and fishing reports and programmed to display the content via the receiver/transmitter or via the advertising website.

Referring in particular to FIG. 1, a more detailed description of the operation of the message/advertising system 100 is as follows. In use, a user will access the message/advertising system 100 utilizing a web page via the internet. The user will login to their profile for which to provide a guideline to receive information from other users of the message/advertising system message/advertising system 100 and/or enter data to be broadcast to other users on the communication network 100. Examples of the data that can be entered by the user can include but is not limited to advertising message, message content, message frequency, message type, audio data, emergency data, payment data, graphic data, textual data, event data, shopping data, financial data and employment data. As items are added, fees will be charged to the user.

Operably connected to the message/advertising system 100 is a plurality of receiver/transmitters 20-60. Each receiver/transmitter contains the necessary electronics to identify current geographic coordinates of the receiver/transmitter and receive, store, manipulate and view data received via the message/advertising system 100. During use a user of the receiver/transmitter will receive data related in part to their current geographic location and profile settings. This process is continuous until the receiver/transmitter is disengaged with the message/advertising system 100. As each receiver/transmitter receives data 40, it is retransmitted so that other receivers/transmitters 50 can receive the data for viewing. Then receiver/transmitter 50 will again retransmit and receiver/transmitter 60, while in range, will start this process.

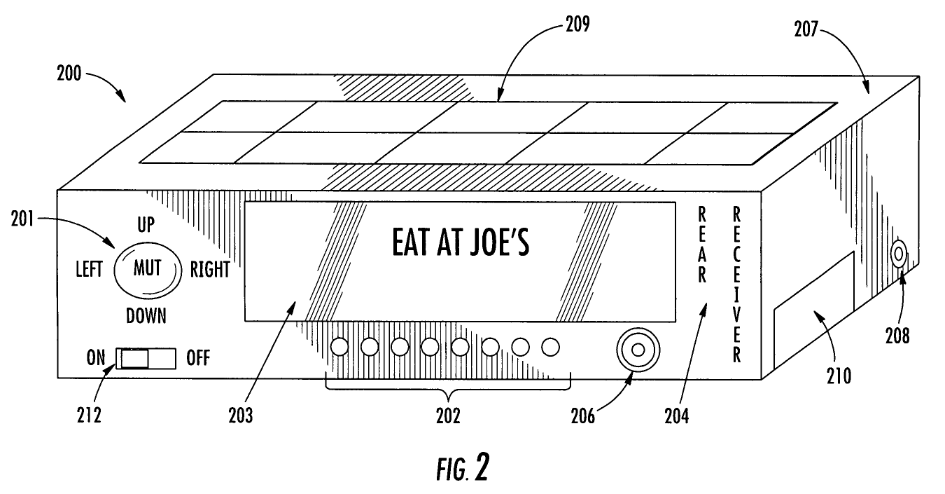

Referring in particular to FIG. 2, there is illustrated a preferred embodiment of a receiver/transmitter 200 as similarly shown in FIG. 1. The receiver/transmitter 200 includes an input controller 201 operable to scroll textual information displayed within the display 203 and mute an audio message being output by the speaker 206. The display 203 includes multi-line or graphic display. It is further contemplated within the scope of the present invention that the display 203 may include other types or combinations of displays. More specifically but not by way of limitation, the display 203 could include a color display, color LCD, thin film transistor display or organic light emitting diode capable of producing higher resolution images and/or colors. An image could be sent via another wireless connection (such as but not limited to Blue-tooth) to be displayed to a larger screen, such as an in-car display, office projector or a computer screen.

The receiver/transmitter 200 further includes a series of illuminators 202 operable to indicate the strength of the signal being received with direction (front, rear, left, right, top, or bottom) by the receiver/transmitter 200. Electronics for the receiver/transmitter 200 are contained within the housing 207 and a power receptacle 208 is provided to enable operably coupling the receiver/transmitter 200 to an external power source such as but not limited to a twelve-volt power source typically associated with many types of vehicles. It is also contemplated within the scope of the present invention that the power receptacle 208 may be adapted to interface with any vehicle's electrical system or may include a removable charge adapter that may be operably coupled to a twelve-volt charge receptacle of a vehicle. It is further contemplated within the scope of the present invention that batteries may be provided within the housing 207 and accessed using a battery access panel 210. Those skilled in the art should recognize that numerous different types of batteries such as but not limited to lithium ion, nickel cadmium or alkaline could be utilized to provide power to the receiver/transmitter 200.

The power receptacle 208 may be utilized to provide charging for rechargeable batteries that are disposed within the housing 207. The receiver/transmitter 200 further includes a photovoltaic panel 209. The photovoltaic panel 209 is integrally mounted to the housing 207 and is operable to convert light waves into electrical energy sufficient to power the receiver/transmitter 200 and could also be used in charging the batteries. The electronics within the housing 207 may include a regulator to regulate the electrical current generated by the photovoltaic panel 209.

The housing 207 is formed of suitable durable material such as but not limited to plastic. It is contemplated within the scope of the present invention that the housing 207 be impact resistant, thermally resistant and water resistant. The housing 207 is formed to be generally rectangular in shape. While no particular size of housing 207 is required, good results have been achieved by utilizing a housing 207 that is approximately three to four inches in width, two to three inches in length and a thickness of approximately one-quarter of an inch. The housing 207 is manufactured utilizing one or more plastic manufacturing processes such as but not limited to injection molding or blow molding. It is further contemplated that the housing 207 be made from lightweight metals.

The receiver/transmitter 200 further includes a power switch 212 operably coupled to a power source such as one or more batteries, a vehicle's power supply or the photovoltaic panel 209. A charge adapter may also be provided as part of the receiver/transmitter 200 that allows for a power source to be converted into usable direct current power for supplying power to the receiver/transmitter 200. The receiver/transmitter 200 may be mounted towards the front of the vehicle superposed the dashboard to facilitate easy access to the operator of the vehicle. It is further contemplated within the scope of the present invention that the receiver/transmitter 200 could be integrally mounted into the vehicle's display panel, windshield, or rearview mirror in order to facilitate the use by the operator of the vehicle in which the receiver/transmitter 200 is mounted. The receiver/transmitter 200 can be mounted to the desired vehicle utilizing a plurality of fasteners. More specifically but not by way of limitation, the receiver/transmitter 200 can be mounted utilizing hook and loop material, suction cups or adhesive materials. Receiver/transmitter device 200 could be integrated into a vehicle's computer to become integrated with the vehicle, thereby eliminating the need for an extra external device.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can to reasonably included within the spirit and scope of the appended claims.

What is claimed is:

1. An apparatus operable to receive data comprising:
a portable communication module, said communication module disposable within the interior of a vehicle operable to receive and transmit data transmissions; and
said portable communication module including a receiver, said receiver being operable to receive the data transmissions from an installed communications network, said communications network for providing the data transmissions.

2. The apparatus as recited in claim 1, wherein said portable communications module further includes a transmitter for transmitting signals utilizing at least one of short wave, RF or cellular frequencies, said signals including at least one of voice signals and data signals, wherein said receiver operable to receive signals transmitted from a different portable communication module.

3. The apparatus as recited in claim 2, and further including a display, said display operable to provide at least one of graphic and textual information derived from the received data transmissions.

4. The apparatus as recited in claim 3, wherein said transmitter further for retransmitting at least one of the received data transmission.

5. The apparatus as recited in claim 4, wherein the installed communications network includes a website, the website operable to control the content and delivery of the data transmissions from the installed communications network.

6. The apparatus as recited in claim 5, wherein said communications module is powered by a DC power source.

7. The apparatus as recited in claim 6, and further including a personal data assistant.

8. An advertising system comprising:
a first messaging device, said first messaging device being portable, said first messaging device operably connected to a communications network, with each first messaging device configured to transmit, receive, store, manipulate and view data; and
a message facility operable to transmit data to first messaging device via the communications network.

9. The advertising system as recited in claim 8, and further including a second messaging device, said second messaging device operably connected to the communications network, said second messaging device configured to transmit, receive, store, manipulate and view data;
said message facility operable to transmit data to the second messaging device via the communications network;
said first messaging device and said second messaging device operable to transmit data therebetween.

10. The advertising system as recited in claim 9, wherein at least one of said first and second messaging devices further includes a display screen, said display screen operable for viewing graphical or textual information.

11. The advertising system as recited in claim 10, wherein at least one of said first and second messaging devices further includes an input device, said input device operable to provide a user with an interface to enter data.

12. The advertising system as recited in claim 11, wherein first messaging device and said second messaging device messaging system operable to wirelessly transmit data therebetween.

13. The advertising system as recited in claim 12, wherein at least one of the first and second messaging devices is powered via DC power source.

14. The advertising system as recited in claim 13, wherein at least one of the first and second messaging devices includes a transmitter is configured to transmit or retransmit data using radio frequencies.

15. A communication network configured to receive and distribute advertising messages comprising:
a plurality of vehicle/personal device messaging systems, each of said plurality of vehicle/personal device messaging systems configured to transmit, receive, store, manipulate and view data, each of said plurality of vehicle/personal device messaging systems operably connected to a communications network; and
a message facility operable to transmit data to at least one of said plurality of vehicle/personal device messaging system via the communications network.

16. The communication network as recited in claim 15, wherein at least one of said plurality of vehicle/personal device messaging systems is configured to be disposed and operable within the interior of a vehicle.

17. The communication network as recited in claim 16, wherein a first of said plurality of vehicle/personal device messaging systems and a second of said plurality of vehicle/personal device messaging system are operable to transmit data there-between.

18. The communication network as recited in claim 17, wherein said at least one of said plurality of vehicle/personal device messaging systems is operable to determine its geographic coordinates and transmit information corresponding to its geographic coordinates to the communication network and is further operable to control the display of data based on the determined geographic coordinates.

19. The communication network as recited in claim 18, wherein at least one of said plurality of vehicle/personal device messaging system is operably connected to the communications network utilizing radio frequencies.

20. The communication network as recited in claim 19, wherein at least one of said vehicle/personal device messaging systems is operable to transmit a request to receive select types of data from at least one of the second of said vehicle/personal devices systems and the communications network.
